(19) United States
(12) Patent Application Publication
(10) Pub. No.: US 2025/0217732 A1
(43) Pub. Date: Jul. 3, 2025

(54) METHODS AND SYSTEMS FOR GENERATING A LIST OF DIGITAL TASKS

(71) Applicant: Y.E. Hub Armenia LLC, Yerevan (AM)

(72) Inventors: Valentin Andreevich BIRYUKOV, Orenburg (RU); Dmitriy Sergeevich KUZNETSOV, Yaroslavl (RU)

(21) Appl. No.: 19/084,701

(22) Filed: Mar. 19, 2025

Related U.S. Application Data
(63) Continuation of application No. 18/082,300, filed on Dec. 15, 2022.

(51) Int. Cl. G06Q 10/0631; G06N 20/20

(52) U.S. Cl. CPC G06Q 10/063112; G06N 20/20

(57) ABSTRACT

A method and system for generating a list of digital tasks to a given assessor, the method comprising: receiving, a request for the list of digital tasks from the given assessor; retrieving a plurality of digital tasks available; determining a respective assessor interaction parameter; obtaining a respective accurate-completion parameter; ranking, the plurality of digital tasks to generate a ranked plurality of digital tasks, the ranking being executed by optimizing a ranking quality parameter, the ranking quality parameter being determined based on a combination of: a user-platform satisfaction parameter; a requester-platform satisfaction parameter; selecting, from the ranked plurality of digital tasks, a top N-number of digital tasks for inclusion thereof in the list of digital tasks.

### CROSS-REFERENCE

The present patent application is a Continuation application of the U.S. patent application Ser. No. 18/082,300 filed on Dec. 15, 2022, the disclosures of which is incorporated by reference herein in its entirety.

### FIELD

The present technology relates to methods and systems generating a list of digital tasks to be provided to a given assessor, or more specifically, generating a list of digital tasks to be provided to a given assessor that is part of a crowd-sourced digital platform.

### BACKGROUND

Crowdsourcing platforms, such as the Amazon Mechanical Turk™, make it possible to coordinate the use of human intelligence to perform tasks that computers are currently unable, in a shorter time and at a lower cost, compared to that needed by professional assessors.

Generally speaking, a crowdsourcing platform operates in a two-sided market ecosystem of requesters who post jobs known as Human Intelligence Tasks (HITs), and users who complete them in exchange for a monetary payment set by the requesters. The key goal of this two-sided market platform is to improve the experience of each side of the market and to make effective matching of their needs.

United States Patent Application Publication No. 2015/254593 A1 published Sep. 10, 2015, to Microsoft Corporation, and titled “Streamlined Creation and Utilization of Reference Human Intelligence Tasks”, discloses reference intelligence tasks are automatically generated for subsequent utilization in crowdsourced processing of intelligence tasks. Reference intelligence tasks are categorized into predetermined categories, including categories defined by an intended utilization of such intelligence tasks. A trusted set of workers are provided with intelligence tasks and, if a specified number of those trusted workers reach consensus as to what is an appropriate answer, then such an answer is a definitive answer. Conversely, if no consensus is initially reached, then additional trusted workers can be utilized to determine if, in combination, consensus can be reached. To frame categorization considerations by the trusted set of workers, they are provided with statistics relevant to categorizations. An automatic category assignment, or reassignment, can be performed if necessary. Additionally, a maximum amount of time by which the automatic generation of a set of reference intelligence tasks is to complete is, optionally, established.

United States Patent Application Publication No. 2009/0204470 A1 published Aug. 13, 2009, to Clearshift Corporation, and titled “Multilevel Assignment of Jobs and Tasks in Online Work Management System”, discloses an online work management system provides a marketplace for multiple job owner and workers. The job owners provide a job description that defines task. The job description may be processed to generate task descriptions that may be published for workers' application. The task descriptions specify the qualification or restrictions for workers to have the task assigned. The online work management system also provides various functions supporting coordination and management of task assignment such as determining the trust level of the user's identity, search the tasks or workers, monitoring the progress of job, managing payment to workers, training and testing the workers, evaluating the review by the job owners, and generation of surveys.

### SUMMARY

Non-limiting embodiments of the present technology have been developed based on developer's appreciation of at least one technical shortcomings over at least some of the prior art solutions.

Firstly, the correctness of the outputs of the tasks performed by human assessors has an impact on training, and eventually on the in-use performance, of a number of machine learning algorithms. If training data includes a large number of erroneous training examples (i.e. training examples with erroneous labels), the in-use performance of a machine learning algorithm trained based on this training data will suffer. Secondly, the selection of tasks by the human assessors are naturally biased based on their preference for, or satisfaction from performance of, certain tasks. In other words, experienced human assessors are more prone to select tasks that are familiar with their previous experience. As such, when a new type of task, unknown to many human assessors becomes available, there tends to be lack of interest by the human assessors to select the new type of task. As such, requesters of new, or unfamiliar tasks, may have a harder time to collect outputs by the human assessors, resulting in a dissatisfaction with the crowdsourcing platform.

Developers of the present technology have developed a technology to allocate unknown or unfamiliar tasks to human assessors by balancing the assessor's satisfaction and the requester's satisfaction. In other words, if a given assessor is unfamiliar or unknown with a given task, but it is likely that the given task would be successfully completed by the given assessor, the crowdsourcing platform is configured to promote the given task while minimizing dissatisfaction of the human assessor.

In accordance with a first broad aspect of the present technology, there is provided a computer-implemented method of generating a list of digital tasks to be provided to a given assessor for selecting for completion of at least one thereof, the given assessor being part of a crowd-sourced digital platform, the method being executable by a processor that also hosts the crowd-sourced digital platform and executing a Machine-Learning algorithm (MLA), the method comprising: receiving, by the processor, a request for the list of digital tasks from the given assessor; retrieving a plurality of digital tasks available for execution in the crowd-sourced digital platform responsive to the request; determining, for a given digital task of the plurality of digital tasks, a respective assessor interaction parameter, the respective assessor interaction parameter being indicative of a likelihood value of the given assessor selecting the given digital task, the assessor interaction parameter being determined based on at least one or more profile parameters associated with the given assessor; obtaining, by the processor, for the given digital task, a respective accurate-completion parameter accurate-completion parameter being indicative of a likelihood value of the given assessor completing the given digital task correctly; ranking, by the MLA, the plurality of digital tasks to generate a ranked plurality of digital tasks, the ranking being executed by optimizing a ranking quality parameter, the ranking quality parameter being determined based on a combination of: (i) a user-platform satisfaction parameter indicative of the given assessor being satisfied based on a position of the given digital task within a ranked list of the plurality of digital tasks, a higher user-platform satisfaction parameter being indicative of the position of the given digital task within the list being aligned with the at least one or more profile parameters of the given assessor, the user-platform satisfaction parameter being determined based on the respective assessor interaction parameter of the plurality of digital tasks; (ii) a requester-platform satisfaction parameter indicative of a likelihood of the given assessor correctly completing the given digital task, a higher requester-platform satisfaction parameter being indicative of the given assessor correctly completing the given digital task being positioned higher within the ranked list, the requester-platform satisfaction parameter being determined based on the respective accurate-completion parameter of the plurality of digital tasks; the optimizing including maximizing the value of the requester-platform satisfaction parameter while maintaining the value of the user-platform satisfaction parameter at a given predetermined level; and selecting, by the processor, from the ranked plurality of digital tasks, a top N-number of digital tasks for inclusion thereof in the list of digital tasks.

In some non-limiting embodiments of the method, the retrieving the plurality of digital tasks available for execution further comprises determining therein a subset of digital tasks, the determining including: generating, by the MLA, a feature vector of the given accessor; generating, by the MLA, a respective feature vector for each digital tasks of the plurality of digital tasks; selecting, by the processor, an N-number of digital tasks from the plurality of digital tasks for inclusion thereof in the subset of digital tasks, based on vector-proximity of the feature vector of the given accessor and respective feature vectors of the plurality of digital tasks.

In some non-limiting embodiments of the method, the user-platform satisfaction parameter is an aggregate value of the assessor interaction parameters associated with the plurality of digital tasks.

In some non-limiting embodiments of the method, the requester-platform satisfaction parameter is an aggregate value of the accurate-completion parameters associated with the plurality of digital tasks.

In some non-limiting embodiments of the method, the respective assessor interaction parameter is indicative of whether the given assessor would click the given digital task or not.

In some non-limiting embodiments of the method, the respective accurate-completion parameter is determined using control digital tasks.

In some non-limiting embodiments of the method, the respective accurate-completion parameter is determined based on a degree of consistency of an answer provided to the given digital task by the given assessor with other answers provided to the given digital task by other assessors of the crowd-sourced platform.

In some non-limiting embodiments of the method, the ranking quality parameter is determined in accordance with an equation:

$$α {\sum }_{r ∈ R} {{\sum }_{i = 1}}^{20} \frac{rel ( {w}_{r} , c ( F ( r ) , i ) )}{log ( i + 1 )} + β {\sum }_{r ∈ R} {{\sum }_{i = 1}}^{20} \frac{acc ( r , {w}_{r} , c ( F ( r ) , i ) )}{log ( i + 1 )} \to {max}_{c ∈ C} ,$$

where rel(wᵣ, c(F(r), i)) is the respective assessor interaction parameter of the given assessor wᵣ with the given digital task F(r);
   acc(r, wᵣ, c(F(r), i)) is the respective accurate-completion parameter associated with the given assessor wᵣ completing the given digital task F(r);
   i is a current position of the given digital task within the list of digital tasks;
   r is the request used for generating the given digital task;
   c is one of learning functions of the MLA; and
   α and β are weight coefficients

In some non-limiting embodiments of the method, the optimizing includes applying one of a Stochastic Rank algorithm and a Yeti Rank Algorithm.

In some non-limiting embodiments of the method, the MLA comprises an ensemble of CatBoost decision trees.

In accordance with another broad aspect of the present technology, there is provided a computer-implemented method of generating a list of digital tasks to be provided to a given assessor for selecting for completion of at least one thereof, the given assessor being part of a crowd-sourced digital platform, the method being executable by a processor that also hosts the crowd-sourced digital platform and executing a Machine-Learning Algorithm (MLA), the method comprising: receiving, by the processor, a request for the list of digital tasks from the given assessor; retrieving a plurality of digital tasks available for execution in the crowd-sourced digital platform; generating, by the MLA, a subset of digital tasks, the generating being executed by: generating, by the MLA, a feature vector of the given accessor; generating, by the MLA, a respective feature vector for each one of the plurality of digital tasks; selecting an N-number of the plurality of digital tasks as the subset of digital tasks, based on vector-proximity of the feature vector of the given accessor and respective feature vectors of the plurality of digital tasks; ranking, by the MLA, the subset of digital tasks into the list of digital tasks, the ranking being executed by optimizing a ranking quality parameter, the ranking quality parameter being determined based on a combination of: (i) an assessor interaction parameter indicative of a predicted likelihood of interaction between the given assessor and a given digital task, based on a set of skills of the given assessor, a value of the assessor interaction parameter being greater for the given digital task having a greater value of the respective assessor interaction parameter is positioned at a higher position within the list of digital tasks; (ii) a displaced task parameter indicative of a negative effect of displacing another digital task from the higher position to a lower position on a user-satisfaction of the given assessor with the crowd-sourced digital platform, the optimizing including maximizing the value of the assessor interaction parameter while maintaining the value of the displaced task parameter at a given predetermined level.

In accordance with another broad aspect of the present technology, there is disclosed a system for generating a list of digital tasks to be provided to a given assessor for selecting for completion of at least one thereof, the given assessor being part of a crowd-sourced digital platform, the system comprising a server, the server hosting the crowd-sourced digital platform, the server comprising a processor configured to execute a Machine-Learning algorithm (MLA), the processor being further configured to: receive, by the processor, a request for the list of digital tasks from the given assessor; retrieve a plurality of digital tasks available for execution in the crowd-sourced digital platform responsive to the request; determine, for a given digital task of the plurality of digital tasks, a respective assessor interaction parameter, the respective assessor interaction parameter being indicative of a likelihood value of the given assessor selecting the given digital task, the assessor interaction parameter being determined based on at least one or more profile parameters associated with the given assessor; obtain, by the processor, for the given digital task, a respective accurate-completion parameter accurate-completion parameter being indicative of a likelihood value of the given assessor completing the given digital task correctly; rank, by the MLA, the plurality of digital tasks to generate a ranked plurality of digital tasks, the ranking being executed by optimizing a ranking quality parameter, the ranking quality parameter being determined based on a combination of: (i) a user-platform satisfaction parameter indicative of the given assessor being satisfied based on a position of the given digital task within a ranked list of the plurality of digital tasks, a higher user-platform satisfaction parameter being indicative of the position of the given digital task within the list being aligned with the at least one or more profile parameters of the given assessor, the user-platform satisfaction parameter being determined based on the respective assessor interaction parameter of the plurality of digital tasks; (ii) a requester-platform satisfaction parameter indicative of a likelihood of the given assessor correctly completing the given digital task, a higher requester-platform satisfaction parameter being indicative of the given assessor correctly completing the given digital task being positioned higher within the ranked list, the requester-platform satisfaction parameter being determined based on the respective accurate-completion parameter of the plurality of digital tasks; the optimizing including maximizing the value of the requester-platform satisfaction parameter while maintaining the value of the user-platform satisfaction parameter at a given predetermined level; and select, by the processor, from the ranked plurality of digital tasks, a top N-number of digital tasks for inclusion thereof in the list of digital tasks.

In some non-limiting embodiments of the system, to retrieve the plurality of digital tasks available for execution, the processor is further configured to determine therein a subset of digital tasks, the determining comprising: generate, by the MLA, a feature vector of the given accessor; generate, by the MLA, a respective feature vector for each digital tasks of the plurality of digital tasks; select, by the processor, an N-number of digital tasks from the plurality of digital tasks for inclusion thereof in the subset of digital tasks, based on vector-proximity of the feature vector of the given accessor and respective feature vectors of the plurality of digital tasks

In some non-limiting embodiments of the system, the user-platform satisfaction parameter is an aggregate value of the assessor interaction parameters associated with the plurality of digital tasks.

In some non-limiting embodiments of the system, the requester-platform satisfaction parameter is an aggregate value of the accurate-completion parameters associated with the plurality of digital tasks

In some non-limiting embodiments of the system, the respective assessor interaction parameter is indicative of whether the given assessor would click the given digital task or not.

In some non-limiting embodiments of the system, the respective accurate-completion parameter is determined using control digital tasks.

In some non-limiting embodiments of the system, the respective accurate-completion parameter is determined based on a degree of consistency of an answer provided to the given digital task by the given assessor with other answers provided to the given digital task by other assessors of the crowd-sourced platform.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a system implemented in accordance with non-limiting embodiments of the present technology.

FIG. 2 depicts a schematic illustration of an assessor data stored in the system of FIG. 1.

FIG. 3 depicts a schematic diagram of a process, executed by the crowdsourcing application of the system of FIG. 1.

FIG. 4 illustrates the plurality of digital tasks included within a data packet of FIG. 3.

FIG. 5 depicts a schematic process of a conventional ranking MLA executable by the crowdsourcing application of the system of FIG. 1.

FIG. 6 depicts a schematic process of the MLA of FIG. 3.

FIG. 7 illustrates a set of draft ranked lists generated by the MLA of FIG. 3.

FIG. 8 depicts a block diagram of a flow chart of a method for generating a list of digital tasks in accordance with a first non-limiting embodiments of the present technology.

FIG. 9 depicts a block diagram of a flow chart of a method for generating a list of digital tasks in accordance with a second non-limiting embodiments of the present technology.

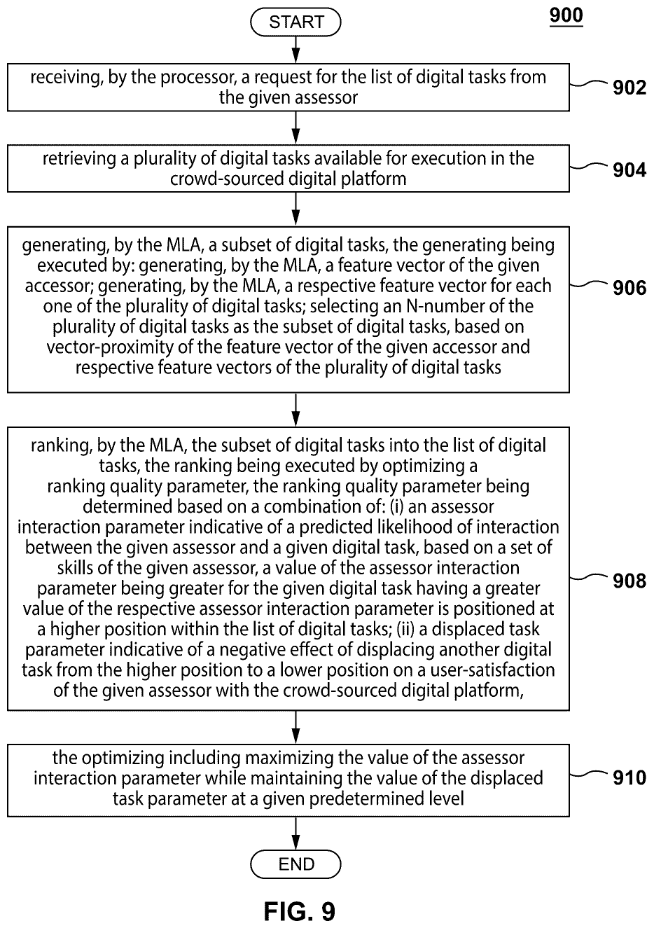

### DETAILED DESCRIPTION

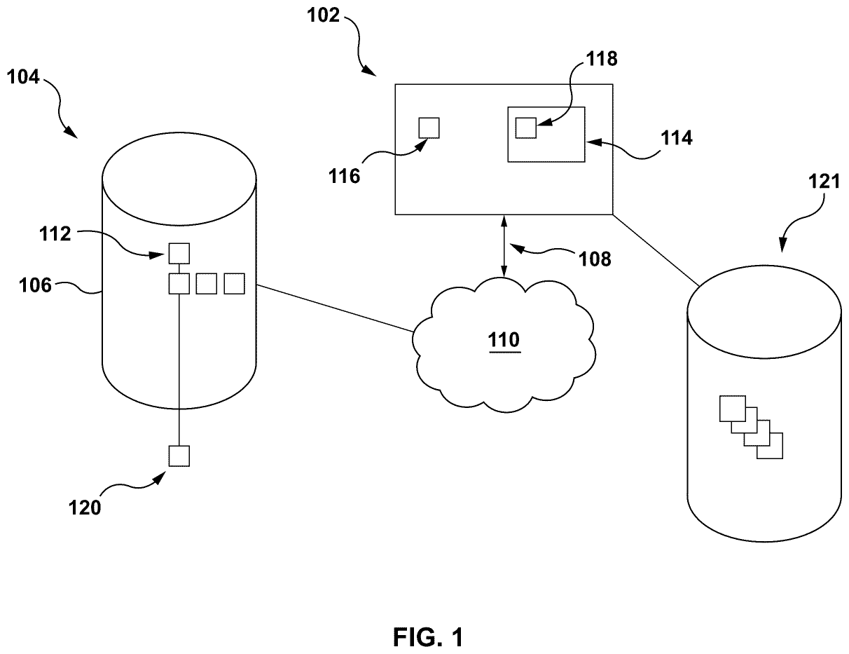

Referring to FIG. 1, there is shown a schematic diagram of a system 100, the system 100 being suitable for implementing non-limiting embodiments of the present technology. Thus, the system 100 is an example of a computer-implemented crowdsourced environment 100.

It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

The system 100 comprises a server 102 and a database 104 accessible by the server 102.

As schematically depicted in FIG. 1, the database 104 comprises an indication for each one of the identity of a plurality of human assessor, who have indicated their availability for completing at least one crowdsourced task. The plurality of human assessor includes a human assessor 106. Needless to say, although only three human assessors are shown within the database 104, this is done for ease of illustration, and it should be understood that the database 104 may store an indication of more or fewer than three human assessors.

In some non-limiting embodiments of the present technology, the database 104 is under control and/or management of a provider of crowdsourced services, such as Yandex LLC of Lev Tolstoy Street, No. 16, Moscow, 119021, Russia. In alternative non-limiting embodiments of the present technology, the database 104 can be operated by a different entity.

The implementation of the database 104 is not particularly limited and, as such, the database 104 could be implemented using any suitable known technology, as long as the functionality described in this specification is provided for. In accordance with the non-limiting embodiments of the present technology, the database 104 comprises (or has access to) a communication interface (not depicted), for enabling two-way communication with a communication network 110.

In some non-limiting embodiments of the present technology, the communication network 110 can be implemented as the Internet. In other non-limiting embodiments of the present technology, the communication network 110 can be implemented differently, such as any wide-area communication network, local area communications network, a private communications network and the like.

It is contemplated that the database 104 can be stored at least in part at the server 102 and/or be managed at least in part by the server 102. In accordance with the non-limiting embodiments of the present technology, the database 104 comprises sufficient information associated with the identity of the human assessor 106 to allow an entity that has access to the database 104, such as the server 102, to assign and transmit one or more tasks to be completed by one or more of the plurality of human assessor.

In accordance with non-limiting embodiments of the present technology, the database 104 stores assessor data 112 associated with each one of the plurality of human assessors. For example, an assessor data 112 is associated with the human assessor 106.

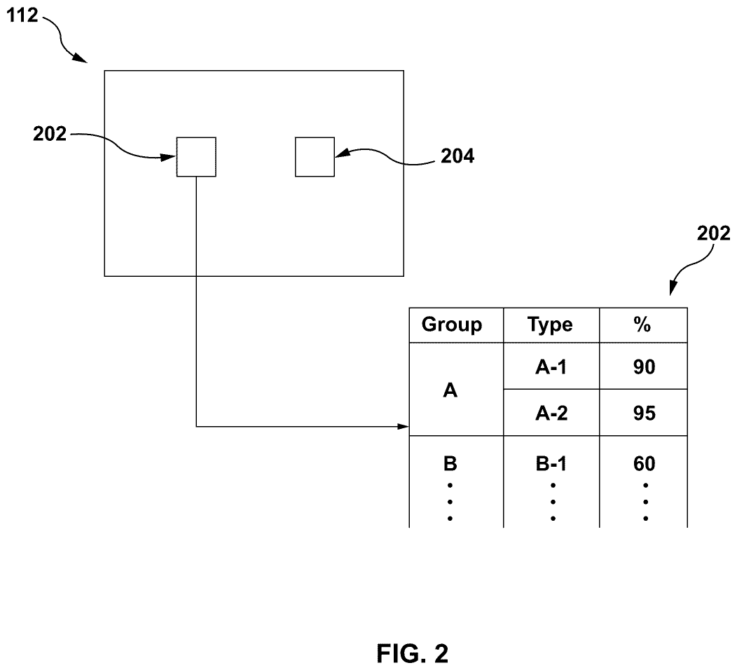

Referring to FIG. 2, there is depicted a schematic illustration of the assessor data 112 (associated with the human assessor 106). As noted above, the assessor data 112 is stored within the database 104. In some non-limiting embodiments, the assessor data 112 may be stored in a storage device different from the database 104.

In accordance with non-limiting embodiments of the present technology, the assessor data 112 comprises an indication of a quality score 202 and a profile data 204 associated with the human assessor 106.

In some non-limiting embodiments of the present technology, the quality score 202 of the human assessor 106 is indicative of a reliability of a given result of for a given task completed by the human assessor 106 (or in other words, an error rate of the human assessor 106 vis-a-vis a given task).

In the context of the present technology, the term “task” corresponds to a specific type of task executed by the human assessor. In some non-limiting embodiments of the present technology, similar type of tasks may be part of a same group of tasks. For example, a given group may correspond to translation tasks, which includes a first type of task corresponding to translating a text from a first language (ex. French) to a second language (ex. English), a second type of task corresponding to translating a text from the first language (ex. French) to a third language (ex. German), and so on. In another example, a given group may correspond to image recognition tasks, which includes a first type of task corresponding to classification (i.e. categorization/classification of an image), a second type of task corresponding to tagging (i.e. assigning one or more tags to a given image), a third type of task corresponding to detection (i.e. identifying an object within a given image), and so on.

How the quality score 202 of the human assessor 106 is determined is not limited. For example, the quality score 202 may be determined based on a first plurality of “honeypot tasks” completed by the human assessor 106. In the present specification, the term “honeypot tasks” means a task the correct result of which is known prior to the task being submitted to the human assessor 106 being tested/assessed for the quality score associated therewith, for completion thereof, which correct result is not provided to the human assessor 106 being assessed.

The results of the first plurality of honeypot tasks provided by the human assessor 106 are recorded in the database 104 in a suitable data structure (not depicted). A percentage of the first plurality of honeypot tasks that the human assessor 106 completes correctly is calculated and recorded in the database 104 as the quality score 202 of the human assessor 106. For example, if the human assessor 106 completes twenty honeypot tasks and provides a result matching the corresponding known correct result to eighteen of the twenty honeypot tasks, then the quality score 202 of the human assessor 106 is determined to be 18/20=0.9 (90%). Needless to say, the quality score may be expressed in a number of different formats.

In some non-limiting embodiments of the present technology, the quality score 202 may be determined based on a statistical analysis of previously completed tasks and checks executed by one or more trusted human assessors. A method of determining the quality score is disclosed in the Russian Patent Application No. 2021106657 entitled METHOD AND SYSTEM FOR GENERATING TRAINING DATA FOR A MACHINE-LEARNING ALGORITHM, and filed Mar. 15, 2021, the content of which is hereby incorporated by reference in its entirety.

Taking the quality score 202 as an example, it is indicative that the human assessor 106 has previously executed 3 types of tasks (identified as “A-1”, “A-2” and “B-1”) with a respective success rate. In other words, the human assessor 106 has executed two types of tasks that fall within a same group (identified as “A”) and a single type of task that falls within a different group (identified as “B”).

For example, the human assessor 106 has: (i) a success rate of 90% for A-1 type tasks, (ii) a success rate of 95% for A-2 type tasks, and (iii) a success rate of 60% for B-1 type tasks.

Needless to say, it should be understood that the quality score 202 is illustrated for the purpose of illustration and in no way are intended to be limiting. It is contemplated that the quality score 202 include more or less groups, types and respective success rates.

The assessor data 112 further comprises a profile data 204, which is indicative of a profile of the human assessor 106, which may include, for example, the age, the gender, the level of education, work experience, the number of tasks and types of tasks completed, and so on. How the profile data 204 is collected is not limited, and may for example be submitted by the human assessor 106 when creating an account and/or collected following completion/selection of digital tasks by the human assessor 106.

Returning now to FIG. 1, the server 102 can be implemented as a conventional computer server. In an example of a non-limiting embodiment of the present technology, the server 102 can be implemented as a Dell™ PowerEdge™ Server running the Microsoft™ Windows Server™ operating system. Needless to say, the server 102 can be implemented in any other suitable hardware and/or software and/or firmware or a combination thereof. In the depicted non-limiting embodiment of the present technology, the server 102 is a single server. In alternative non-limiting embodiments of the present technology, the functionality of the server 102 may be distributed and may be implemented via multiple servers.

The server 102 comprises a communication interface (not depicted) for enabling two-way communication with the communication network 110 via a communication link 108.

How the communication link 108 is implemented is not particularly limited and depends on how the server 102 is implemented. For example, the communication link 108 can be implemented as a wireless communication link (such as, but not limited to, a 3G communications network link, a 4G communications network link, a Wireless Fidelity, or WiFi®, for short, Bluetooth®, or the like) or as a wired communication link (such as an Ethernet based connection).

It should be expressly understood that implementations of the server 102, the communication link 108 and the communication network 110 are provided for illustration purposes only. As such, those skilled in the art will easily appreciate other specific implementational details for the server 102, the communication link 108, and the communication network 110. As such, by no means the examples provided hereinabove are meant to limit the scope of the present technology.

The server 102 comprises a server memory 114, which comprises one or more storage media and generally stores computer-executable program instructions executable by a server processor 116. By way of example, the server memory 114 may be implemented as a tangible computer-readable storage medium including Read-Only Memory (ROM) and/or Random-Access Memory (RAM). The server memory 114 may also include one or more fixed storage devices in the form of, by way of example, hard disk drives (HDDs), solid-state drives (SSDs), and flash-memory cards.

In some non-limiting embodiments of the present technology, the server 102 can be operated by the same entity that operates the database 104. In alternative non-limiting embodiments of the present technology, the server 102 can be operated by an entity different from the one that operates the database 104.

In some non-limiting embodiments of the present technology, the server 102 is configured to execute a crowdsourcing application 118. For example, the crowdsourcing application 118 may be implemented as a crowdsourcing platform such as Yandex.Toloka™ crowdsourcing platform, or other proprietary or commercial crowdsourcing platform.

To that end, the server 102 is communicatively coupled to a task database 121. In alternative non-limiting embodiments of the present technology, the task database 121 may be communicatively coupled to the server 102 via the communication network 110. Although the task database 121 is illustrated schematically herein as a single entity, it is contemplated that the task database 121 may be configured in a distributed manner.

The task database 121 is populated with a plurality of human intelligence tasks (HITs, hereinafter “digital task” or, simply “tasks”) (not separately numbered).

How the task database 121 is populated with the plurality of tasks is not limited. Generally speaking, one or more requesters (not shown) may submit one or more tasks to be completed to the crowdsourcing application 118 (which are then stored in the task database 121). In some non-limiting embodiments of the present technology, the one or more requesters may associate task-specific data, such as the group, the type, difficulty of the task, completion time frame, cost per completed task, the number of human assessors who need to complete the same digital task, and/or a budget to be allocated to a total pool of human assessors completing the task(s).

It should be understood that the task database 121 includes uncompleted digital tasks having similar type or group to those previously executed by the human assessor 106, as well as uncompleted digital tasks associated with one or more groups of tasks (and types) not previously completed (or unknown) by the human assessor 106.

As has been alluded to above, the task database 121 includes digital tasks that, when submitted to a human assessor, provide instructions to the human assessor for completing the task. The human assessor may input its answer (using a label, text, and the like), which is used by the requester as training data for training a machine learning algorithm.

The server 102 is configured to communicate with various entities via the communication network 110. Examples of the various entities include the database 104, an electronic device 120 associated with each one of the plurality of human assessors, and other devices that may be coupled to the communication network 110. Accordingly, the crowdsourcing application 118 is configured to retrieve a given task from the task database 121 and send the given task to the electronic device 120 used by the human assessor 106 to complete the given task, via the communication network 110 for example. Similarly, in some non-limiting embodiments of the present technology, the server 102 is configured to receive a set of responses to the tasks that has been completed by the human assessor 106.

It is contemplated that any suitable file transfer technology and/or medium could be used for this purpose. It is also contemplated that the task could be submitted to the human assessor 106 via any other suitable method, such as by making the task remotely available to the human assessor 106.

In at least some embodiments of the present technology, it is contemplated that the digital tasks in the task database 121 may comprise data labelling tasks, meaning that the response provided by a given human assessor may be used for determining and/or may be representative of a “label” for a respective dataset. For example, if the given digital task is of the image classification type, and in a sense “tasks” a human assessor to provide a response indicative of whether a given image (dataset) is an image of a dog or of a cat, the response provided by the human assessor may represent a label for the given image and which is indicative of a presence of animal on the given image.

Such data labelling tasks may be used for training a verity of machine learning algorithms. For example, a machine learning algorithm may be any of various conventional machine learning algorithms, including, without limitation, “deep learning” algorithms, other types of neural networks or “connectionist” systems, decision trees, decision forests, Bayesian networks, or other known or later developed machine learning algorithms that use training datasets (e.g., supervised or semi-supervised learning algorithms).

In the example presented immediately above, the given image (dataset) and the response (label) may form a training set for training an image classification algorithm. The image classification algorithm may be trained in a supervised manner by using a large number of training sets generated in a similar manner to what has been described above. In at least one implementations of the present technology, the image classification algorithm may be a particular class of machine learning algorithms, such as a Convolution Neural Network, for example.

Although the description of the system 100 has been made with reference to various hardware entities (such as the database 104, the server 102, the task database 121 and the like) depicted separately, it should be understood that this is done for ease of understanding. It is contemplated that the various functions executed by these various entities be executed by a single entity or be distributed among different entities.

### Crowdsourcing Application 118

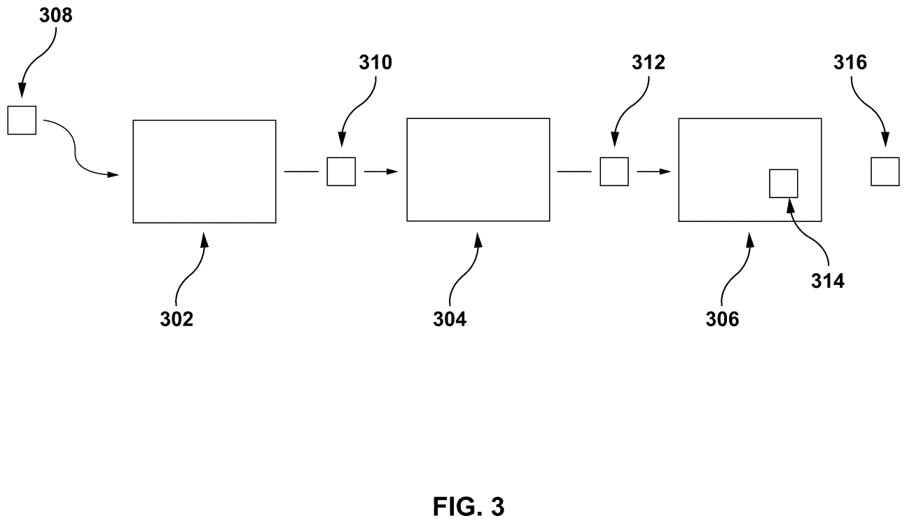

With reference to FIG. 3, there is depicted a schematic diagram of a process, executed by the crowdsourcing application 118, for generating a ranked list of digital tasks to be provided to a given human assessor.

The crowdsourcing application 118 executes (or otherwise has access to): a receiving routine 302, a parameter routine 304, and a ranking routine 306.

In the context of the present specification, the term “routine” refers to a subset of the computer executable program instructions of the crowdsourcing application 118 that is executable by the server processor 116 (the receiving routine 302, the parameter routine 304, and the ranking routine 306). For the avoidance of any doubt, it should be expressly understood that the receiving routine 302, the parameter routine 304, and the ranking routine 306 are illustrated herein as separate entities for ease of explanation of the processes executed by the crowdsourcing application 118. It is contemplated that some or all of the receiving routine 302, the parameter routine 304, and the ranking routine 306 may be implemented as one or more combined routines.

For ease of understanding the present technology, functionality of each of the receiving routine 302, the parameter routine 304, and the ranking routine 306, as well as data and/or information processed or stored therein are described below.

The following description of the functionality of each one of the receiving routine 302, the parameter routine 304, and the ranking routine 306 is primarily made from the perspective of an in-use phase of the crowdsourcing application 118.

### Receiving Routine 302

The receiving routine 302 is configured to receive a data packet 308 from the human assessor 106. The data packet 308 comprises a request by a human assessor 106 for a list of digital tasks. For example, the request may correspond to an indication that the human assessor 106 is available to complete one or more digital tasks. In some non-limiting embodiments of the present technology, the data packet 308 may be transmitted from the electronic device 120 associated with the human assessor 106 accessing the crowdsourcing application 118.

In some non-limiting embodiments of the present technology, in response to the receiving the data packet 308, the receiving routine 302 is configured to and retrieve the assessor data 112 associated with the human assessor 106 from the database 104.

In some non-limiting embodiments of the present technology, the receiving routine 302 is then configured to generate a vector representation of the assessor data 112. How the vector representation is generated is not limited and it is well known in the art. Suffice it to say that the receiving routine 302 may be configured to execute a machine learning algorithm (MLA) (not shown) configured to generate an assessor vector of the assessor data 112. Recalling that the assessor data 112 comprises the quality score 202 and the profile data 204, the assessor vector may be generated based on the quality score 202 and the profile data 204 or with only one of the quality score 202 and the profile data 204.

In some non-limiting embodiments of the present technology, the receiving routine 302 is further configured to access the task database 121 and select one or more digital tasks based on the assessor vector. More specifically, the receiving routine 302 is configured to generate a respective task feature vector for each digital task included within the task database 121 based on their respective task-specific data. The receiving routine 302 is then configured to calculate a respective vector-proximity of between the assessor vector and the one or more task feature vectors.

How the vector-proximity between the assessor vector and the one or more task feature vectors is calculated is known in the art and will not be described in detail herein. Suffice it to say that the assessor vector and the one or more task feature vectors are mapped into a multi-dimensional vector space, and the distance between the one or more task feature vectors (such as angular distance between vectors) is calculated.

For example, assuming that there are 100 digital tasks within the task database 121, the receiving routine 302 is configured to generate a task feature vector for each of the 100 digital tasks and calculate the vector-proximity of each 100 task feature vectors vis-a-vis the assessor vector.

In some non-limiting embodiments of the present technology, the receiving routine 302 is further configured to select an N-number of digital tasks having a closest proximity with the assessor vector. It should be understood that the N-number may correspond to any number set by an administrator of the crowdsourcing application 118. Needless to say, instead of selecting N-number of digital tasks, it is also contemplated that the receiving routine 302 select one or more digital tasks having a vector-proximity value above a predefined threshold.

Having selected a plurality of digital tasks based on the vector proximity, the receiving routine 302 is configured to transmit a data packet 310 to the parameter routine 304, the data packet 310 comprising the plurality of digital tasks.

Needless to say, although in the above description the assessor vector and the respective task feature vectors have been generated by the receiving routine 302, it is not limited as such. It is contemplated that the assessor vector and the respective task feature vectors were previously generated and stored within the database 104 and the task database 121, respectively.

In some non-limiting embodiments of the present technology, instead of selecting the N-number of digital tasks, it is contemplated that the receiving routine 302 is configured to, in response to receive the data packet 308, access the task database 121 and retrieve a plurality of digital tasks. For example, the receiving routine 302 is configured to retrieve the plurality of digital tasks corresponding to digital tasks that have been recently submitted by one or more requesters and uncompleted by a predetermined number of human assessors. In some non-limiting embodiments of the present technology, the receiving routine 302 may then select the N-number of digital tasks having a closest proximity with the assessor vector.

### Parameter Routine 304

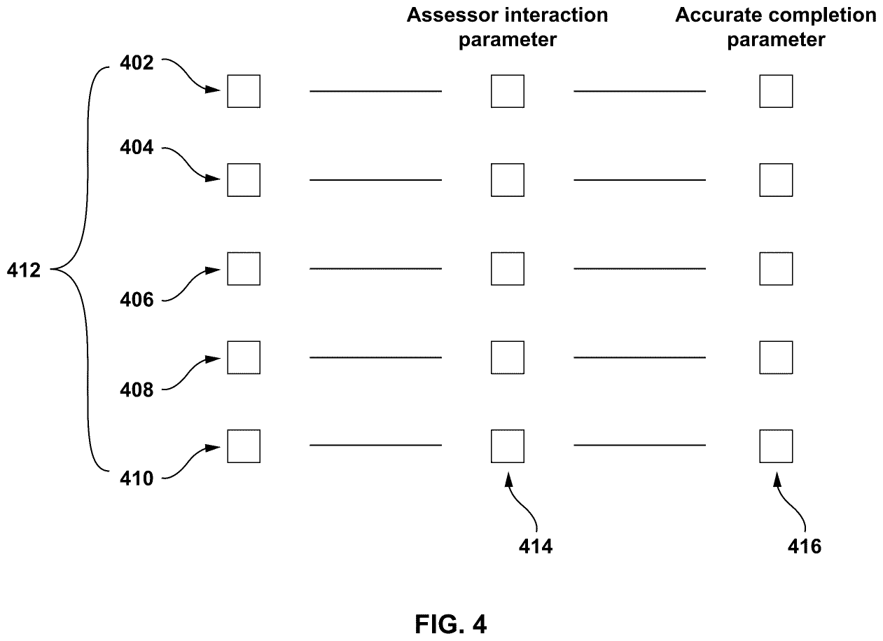

With reference to FIG. 4, there is depicted a schematic illustration of the plurality of digital tasks included within the data packet 310. The data packet 310 includes at least a first digital task 402, a second digital task 404, a third digital task 406, a fourth digital task 408 and a fifth digital task 410. Together, the first digital task 402, the second digital task 404, the third digital task 406, the fourth digital task 408 and the fifth digital task 410 form a plurality of digital tasks 412. Needless to say, although only five digital tasks are included within the plurality of digital tasks 412, it is not limited as such and may include more or fewer than five digital tasks.

In response to receiving the data packet 310, the parameter routine 304 is configured to determine (i) a respective assessor interaction parameter and (ii) a respective accurate-completion parameter.

In some non-limiting embodiments of the present technology, the assessor interaction parameter is indicative of a likelihood value of the human assessor 106 (such as the human assessor 106) selecting a given digital task. More specifically, the parameter routine 304 is configured to determine a respective assessor interaction parameter for each digital tasks included within the plurality of digital tasks 412 (the first digital task 402, the second digital task 404, the third digital task 406, the fourth digital task 408 and the fifth digital task 410).

How the assessor interaction parameter is determined is not limited. In some non-limiting embodiments of the present technology, the parameter routine 304 is configured to execute a machine learning algorithm (not shown) trained to, for a given digital task, receive the assessor vector and the task feature vector associated with the given digital task and output the assessor interaction parameter associated with the given digital task. How the machine learning algorithm is trained is not limited and may for example, be based on a set of training assessor vectors, a set of training task feature vectors, and a set of training labels indicative of a presence of past interaction between training assessors (illustrated by their respective training assessor vector) and each of the training digital tasks (illustrated by their respective training task feature vector).

Let us assume that the parameter routine 304 has determined a set of assessor interaction parameter 414 including a respective assessor interaction parameter associated with each of the first digital task 402, the second digital task 404, the third digital task 406, the fourth digital task 408 and the fifth digital task 410 form the plurality of digital tasks 412 (not separately numbered).

In some non-limiting embodiments of the present technology, the accurate-completion parameter is indicative of a likelihood value of the human assessor 106 (such as the human assessor 106) completing each digital task included within the plurality of digital tasks 412 (the first digital task 402, the second digital task 404, the third digital task 406, the fourth digital task 408 and the fifth digital task 410).

How the accurate-completion parameter is determined is now explained. In some non-limiting embodiments of the present technology, the parameter routine 304 is configured to generate the accurate-completion parameter for a given digital task based on at least one of the following set of features:
An accuracy feature, the accuracy feature corresponding to the quality score 202 of the human assessor 106;
A completion time feature, the completion time feature corresponding to a predicted time period for the human assessor 106 to complete the given digital task, the completion time feature being determined by analyzing the time required for the human assessor 106 to previously complete digital tasks that are similar to the type of the given task, or fall within the same group of the given task;
A completion feature, the completion feature corresponding to a proportion of digital tasks of the similar type (or falling within the same group of the given task) being completed to a total number of digital tasks previously selected by the human assessor 106;

How the accurate-completion parameter is determined is not limited. In some non-limiting embodiments of the present technology, the parameter routine 304 is configured to execute a machine learning algorithm (not shown) trained to, for a given digital task, receive the assessor vector, the task feature vector associated with the given digital task, and the set of features, and output the accurate-completion parameter associated with the given digital task. How the machine learning algorithm is trained is not limited and may for example, be based on a set of training assessor vectors, a set of training task feature vectors, the respective set of features, and a set of training labels indicative of whether the training assessors (illustrated by their respective training assessor vector) has correctly completed each of the training digital tasks (illustrated by their respective training task feature vector).

Let us assume that the parameter routine 304 has determined a set of accurate-completion parameter 416 including a respective accurate-completion parameter associated with each of the first digital task 402, the second digital task 404, the third digital task 406, the fourth digital task 408 and the fifth digital task 410 form the plurality of digital tasks 412 (not separately numbered).

Returning to FIG. 3, having generated the assessor interaction parameter and the accurate-completion parameter for each digital task included within the plurality of digital tasks 412, the parameter routine 304 is configured to transmit a data packet 312 to the ranking routine 306. The data packet 312 comprises the plurality of digital tasks 412 together with the set of assessor interaction parameter 414 and the set of accurate-completion parameter 416.

### Ranking Routine 306

In response to receiving the data packet 312, the ranking routine 306 is configured to execute a machine learning algorithm (MLA) 314 configured to generate a ranked list of the plurality of digital tasks 412.

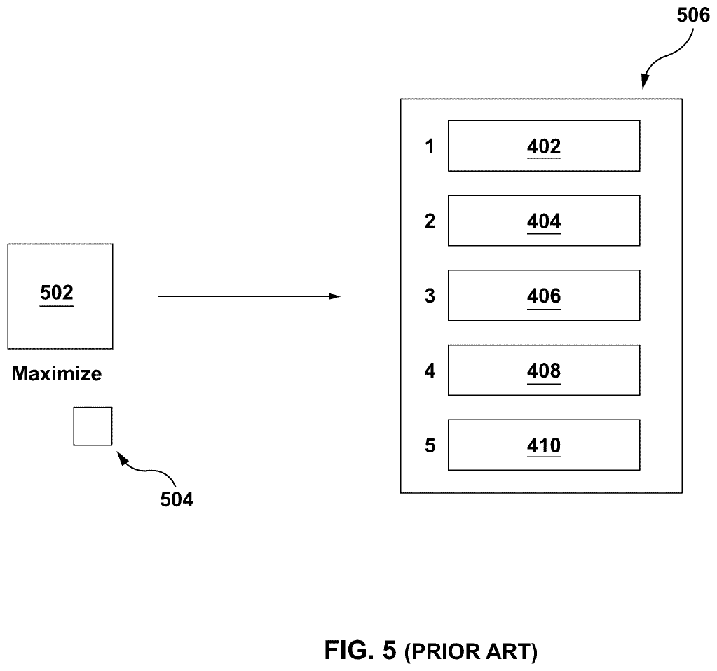

Prior to explaining the MLA 314, a brief reference is made to FIG. 5 illustrating a schematic process of a ranking MLA 502 previously used in ranking the plurality of digital tasks 412, as known in the art. For the avoidance of any confusion, both the description of the MLA 314 is presented for the purposes of illustrating the technical effect of employing the MLA 502, which is implemented in accordance with the non-limiting embodiments of the present technology.

### Ranking MLA 502

The ranking MLA 502 is configured to rank the plurality of digital tasks 412 such that a user-platform satisfaction parameter 504 is maximized. In the context of the present technology, the user-platform satisfaction parameter 504 is indicative of a predicted likelihood the human assessor 106 being satisfied with the ranked position of the plurality of the digital tasks 412 within a conventional ranked list 506 generated by the ranking MLA 502.

How the user-platform satisfaction parameter 504 is determined is not limited. For example, the ranking routine 306 may analyze the profile data 204 (see FIG. 2) of the human assessor 106 and infer one or more profile parameters, such as preferred group, types or digital tasks, difficulty, desired income, estimated time of completion, and the like. The process of maximizing the user-platform satisfaction parameter 504 in generating the conventional ranked list 506 is well known in the art and therefore will not be described in detail herein. Suffice it to say that the ranking MLA 502 is then configured to rank the plurality of the digital tasks 412 such that the relative ranked position of the digital tasks reflects a degree of alignment with the one or more profile parameters.

As it is well known in the art, the performance of the ranking MLA 502 (or any other MLA to that matter) may be “fine-tuned” by evaluating the performance of the output ranked lists using different methods, such as, but not limited to DCG (Discounted Cumulative Gain).

Let us assume, for example, that the ranking MLA 502 has generated the conventional ranked list 506 where it ranked the plurality of digital tasks 412 where the first digital task 402 has been ranked at a highest position, followed by the second digital task 404, the third digital task 406, the fourth digital task 408 and the fifth digital task 410, in that order. In other words, the ranking MLA 502 has determined that the first digital task 402 is the most aligned with the one or more profile parameters of the human assessor 106, and the fifth digital task 410 is the less aligned with the one or more profile parameters of the human assessor 106, within the plurality of digital tasks 214.

It should be understood from the above that, the ranked order of the plurality of digital tasks 412 within the conventional ranked list 506 is based on the highest value of the user-platform satisfaction parameter 504 vis-a-vis other ranked order of the plurality of digital tasks 412.

Indeed, the ranking MLA 502 maximizes the user-platform satisfaction parameter 504 in order to best align the ranking of the plurality of digital tasks 412 such that the assessor 106 will likely click one of the top ranked digital tasks and not perform additional searches. It should therefore be understood that by maximizing the user-platform satisfaction parameter 504, the ranking MLA 502 satisfies the need of the human assessor 106 by displaying digital tasks known to be of interest to the human assessor 106 at a higher position than digital tasks unknown or disliked by the human assessor 106.

In other words, if the ranking of the plurality of digital tasks 412 were to be ordered differently, the value of the user-platform satisfaction parameter 504 would be of a lesser value than the user-platform satisfaction parameter 504 of the conventional ranked list 506. For example, if the first digital task 402 was to be ranked at a lower position, the value of the user-platform satisfaction parameter 504 would be of a lesser value than the user-platform satisfaction parameter 504 of the conventional ranked list 506. As such, it could be stated that by maximizing the user-platform satisfaction parameter 504, the ranking MLA 502 minimizes the dissatisfaction of the human assessor 106 with the conventional ranked list 506.

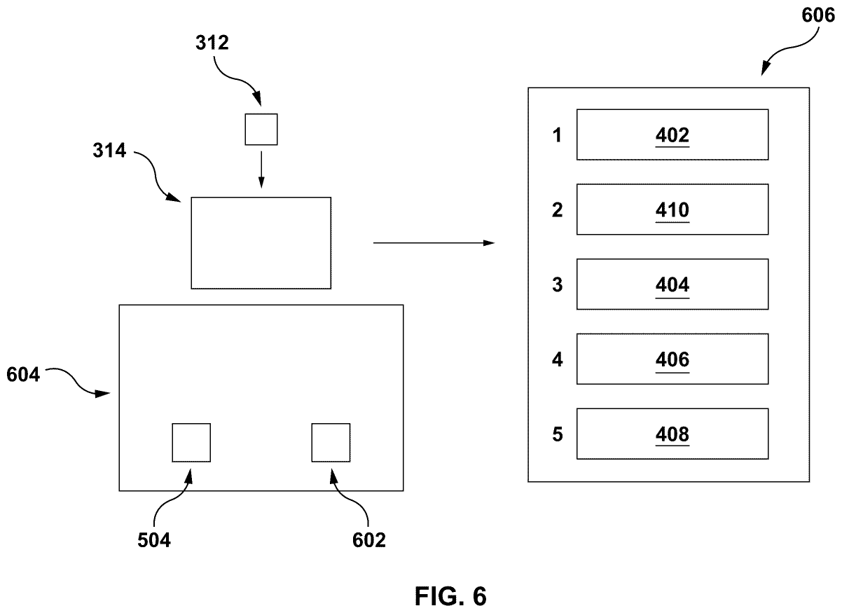

Having explained the ranking MLA 502, reference is now made to FIG. 6, illustrating a schematic process of the MLA 314 used in ranking the plurality of digital tasks 412.

### MLA 314

In response to receiving the data packet 312, the ranking routine 306 is configured to generate a ranking quality parameter 604. In some non-limiting embodiments of the present technology, the ranking quality parameter 604 is one of an input feature for the MLA 314 to generate a ranked list 606 of the plurality of digital tasks 412. How the MLA 314 is implemented is not limited. In some non-limiting embodiments of the present technology, the MLA 314 comprises an ensemble of CatBoost decision trees.

In some non-limiting embodiments of the present technology, the ranking quality parameter 604 comprises the user-platform satisfaction parameter 504 and a requester-platform satisfaction parameter 602.

In the context of the present technology, the requester-platform satisfaction parameter 602 is indicative of a likelihood of the human assessor 106 correctly completing the digital tasks included within the plurality of digital tasks 412 at a given ranked position within the list 606. For example, a given digital task that is likely to be completed correctly by the human assessor 106 will be assigned higher requester-platform satisfaction parameter 602 and thus be positioned higher within the ranked list 606. How the requester-platform satisfaction parameter 602 is determined is not limited and may be determined based on the set of accurate-completion parameter 416 (described in detail below). How the requester-platform satisfaction parameter 602 is implemented is not limited, and may for example correspond to a numerical value within a range (ex. between 0 and 1 or a percentage value and the like).

It should be understood that the requester-platform satisfaction parameter 602 differs from the user-platform satisfaction parameter 504 as it does not take into account the one or more profile parameters of the human assessor 106, but rather represents a likelihood of the digital tasks being correctly completed by the human assessor 106.

Simply put, the user-platform satisfaction parameter 504 is a proxy parameter of the human assessor 106 being satisfied with the positions of the digital tasks within the ranked list 606, and the requester-platform satisfaction parameter 602 is a proxy parameter of the requester(s) of the digital task(s) being satisfied with the position(s) of the digital task(s) within the ranked list 606 in order to achieve the number of human assessors who need to complete the same digital task. This is based on the assumption of the developers of the present technology that even if a given digital content item does not align with the one or more profile parameters of the human assessor 106 (since the given digital content item is a new type or group of digital task that the human assessor 106 has never seen), it may be desirable to take into account how likely the human assessor 106 will properly complete the given digital task, to satisfy the need of the requester of the given digital task (i.e. a need for correct answers).

In some non-limiting embodiments of the present technology, the ranking quality parameter is 604 is inputted into the MLA 314 to generate the ranked list 606.

In some non-limiting embodiments of the present technology, the MLA 314 is configured to generate the ranked list 606 by optimizing the ranking quality parameter 604. In some non-limiting embodiments of the present technology, the optimizing the ranking quality parameter 604 comprises maximizing the value of the requester-platform satisfaction parameter 602 while maintaining the value of the user-platform satisfaction parameter 504 to a predetermined target value.

In other words, unlike the ranking MLA 502 that is configured to generate the conventional ranked list 506 by maximizing the user-platform satisfaction parameter 504, the MLA 314 is configured to maximizing the requester-platform satisfaction parameter 602 up to a certain threshold defined by the predetermined target value of the user-platform satisfaction parameter 504. How the predetermined target value of the user-platform satisfaction parameter 504 is determined is not limited, and may be empirically determined.

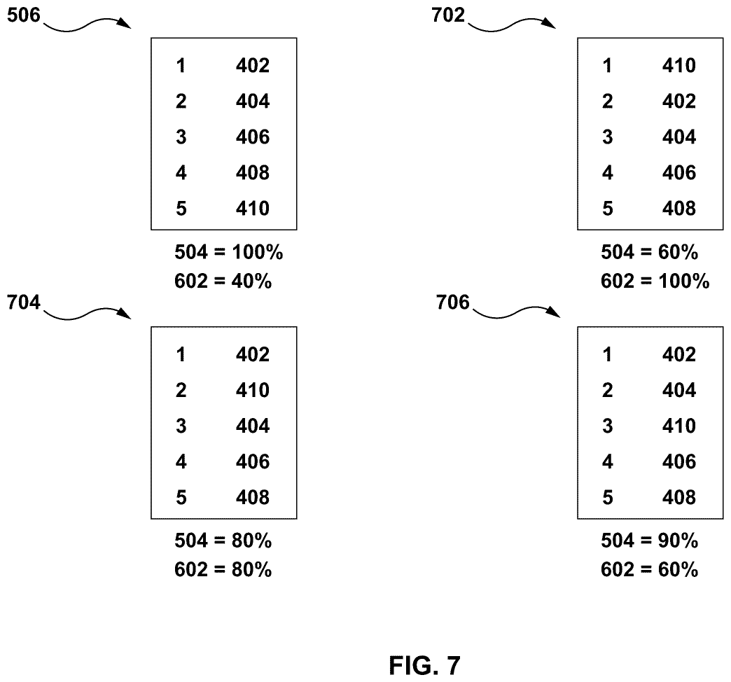

For example, referring now to FIG. 7, there are shown four draft ranked lists generated by the MLA 314 in response to receiving the data packet 312, namely the conventional ranked list 506, a first draft list 702, a second draft list 704 and a third draft list 706 having been generated in response to receiving the data packet 312. Although only four draft ranked lists are illustrated, this is done for ease of understanding and it should be understood that the MLA 314 may generate more or fewer draft ranked lists.

Let us assume, for the purpose of explanation, that the fifth digital task 410 is a digital task of a type or a group that does not align with the one or more profile parameters of the human assessor 106, but is determined, based on the accurate-completion parameter associated with the fifth digital task 410, that it has a high likelihood of being correctly completed by the human assessor 106.

Each of the conventional ranked list 506, the first draft list 702, the second draft list 704 and the third draft list 706 is associated with a respective user-platform satisfaction parameter 504 and requester-platform satisfaction parameter 602.

As illustrated in FIG. 7, it should be apparent that (i) the user-platform satisfaction parameter 504 is maximized in the conventional ranked list 506, and (ii) the user-platform satisfaction parameter 504 lowers in response to the fifth digital task 410 increasing in its ranking, as further illustrated in the table below:

TABLE 1

| | Ranked position | User-platform | Requester platform |
|---|---|---|---|
| Ranked | of fifth digital | satisfaction | satisfaction |
| list | task 410 | parameter 504 | parameter 602 |
| 506 | 5 | 100% | 40% |
| 702 | 1 | 60% | 100% |
| 704 | 2 | 80% | 80% |
| 706 | 3 | 90% | 60% |

Taking a look at the conventional ranked list 506, the user-platform satisfaction parameter 504 is maximized (and therefore at 100%), and the requester-platform satisfaction parameter 602 corresponds to 40%.

In the first draft list 702, the fifth digital task 410 is placed at the first ranked position (thereby replacing the first digital task 402 in the conventional ranked list 506), followed by the first digital task 402, and the second digital task 404 and so on. The user-platform satisfaction parameter 504 corresponds to 60% and the requester platform satisfaction parameter 602 corresponds to 100%, meaning that the requester-platform satisfaction parameter 602 is maximized in the first draft list 702.

In the second draft list 704, the first digital task 402 is at the first ranked position, followed by the fifth digital task 410 and the second digital task 404 and so on. The user-platform satisfaction parameter 504 corresponds to 80% and the requester-platform satisfaction parameter 602 corresponds to 80%.

As has been alluded above, the MLA 314 is configured to maximize the requester-platform satisfaction parameter 602 while respecting the predetermined target value of the user-platform satisfaction parameter 504. Let us assume that the predetermined target value corresponds to 80%, the MLA 314 is configured to select the draft list that has a highest value of the requester-platform satisfaction parameter 602 that also has the user-platform satisfaction parameter 504 above 80%. As such, the MLA 314 is configured to select the second draft list 704 as the ranked list 606.

In other words, the MLA 314 is configured to generate the ranked list 606 that maximizes the requester-platform satisfaction parameter 602 while minimizing the dissatisfaction of the human assessor 106 (illustrated as a decreasing change in the user-platform satisfaction parameter 504) to the predetermined target value.

In some non-limiting embodiments of the present technology, the ranking quality parameter 604 is determined in accordance with the following equation:

$$α {\sum }_{r ∈ R} {{\sum }_{i = 1}}^{20} \frac{rel ( {w}_{r} , c ( F ( r ) , i ) )}{log ( i + 1 )} + β {\sum }_{r ∈ R} {{\sum }_{i = 1}}^{20} \frac{acc ( r , {w}_{r} , c ( F ( r ) , i ) )}{log ( i + 1 )} \to {max}_{c ∈ C} , \qquad Equation 1$$

$$where$$

$$α {\sum }_{r ∈ R} {{\sum }_{i = 1}}^{20} \frac{rel ( {w}_{r} , c ( F ( r ) , i ) )}{log ( i + 1 )} . \qquad Equation 2$$

corresponds to the user-platform satisfaction parameter 504; and
   where

$$β {\sum }_{r ∈ R} {{\sum }_{i = 1}}^{20} \frac{acc ( r , {w}_{r} , c ( F ( r ) , i ) )}{log ( i + 1 )} . \qquad Equation 3$$

corresponds to the requester-platform satisfaction parameter 602; and
where rel(wᵣ, c(F(r), i)) is the respective assessor interaction parameter of the given assessor wᵣ with the given digital task F(r);
   acc(r, wᵣ, c(F(r), i)) is the respective accurate-completion parameter associated with the given assessor wᵣ completing the given digital task F(r);
   i is a current position of the given digital task within the list of digital tasks;
   r is the request used for generating the given digital task;
   c is one of learning functions of the MLA; and
   α and β are weight coefficients that may be determined empirically.

As illustrated above, the user-platform satisfaction parameter 504 corresponds to an aggregate of the respective assessor interaction parameters of the plurality of digital tasks 412, and the requester-platform satisfaction parameter 602 corresponds to an aggregate of the accurate-completion parameters of the plurality of digital tasks 412.

In some non-limiting embodiments of the present technology, optimizing includes applying one of a Stochastic Rank algorithm and a Yeti Rank Algorithm.

Returning to FIG. 3, in response to the ranking routine 306 generating the ranked list 606, the ranking routine 306 is configured to transmit a data packet 316 comprising the ranked list 606 to the electronic device 120 associated with the human assessor 106.

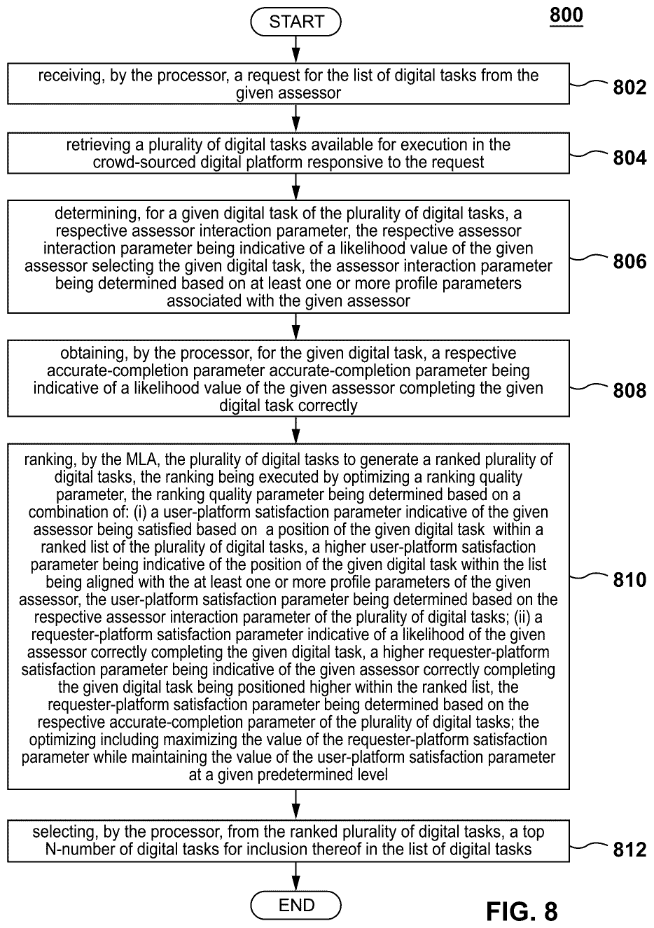

Given the architecture and examples provided herein above, it is possible to execute a computer-implemented method for allocating tasks in a computer-implemented crowdsource environment. With reference to FIG. 8, there is depicted a flow chart of a method 800, the method 800 being executable in accordance with non-limiting embodiments of the present technology. The method 800 can be executed by the server 102.

Step 802: Receiving, by the Processor, a Request for the List of Digital Tasks from the Given Assessor

The method 800 starts at step 802, where the receiving routine 302 is configured to receive a data packet 308 from the human assessor 106. The data packet 308 comprises a request by a human assessor 106 for a list of digital tasks.

For example, the request may correspond to an indication that the human assessor 106 is available to complete one or more digital tasks. In some non-limiting embodiments of the present technology, the data packet 308 may be transmitted from the electronic device 120 associated with the human assessor 106 accessing the crowdsourcing application 118.

In some non-limiting embodiments of the present technology, in response to the receiving the data packet 308, the receiving routine 302 is configured to and retrieve the assessor data 112 associated with the human assessor 106 from the database 104.

In some non-limiting embodiments of the present technology, the receiving routine 302 is then configured to generate the vector representation of the assessor data 112. In some non-limiting embodiments of the present technology, the receiving routine 302 is further configured to access the task database 121 and select one or more digital tasks based on the assessor vector. More specifically, the receiving routine 302 is configured to generate the respective task feature vector for each digital task included within the task database 121 based on their respective task-specific data. The receiving routine 302 is then configured to calculate a respective vector-proximity of between the assessor vector and the one or more task feature vectors.

Step 804: retrieving a plurality of digital tasks available for execution in the crowd-sourced digital platform responsive to the request

At step 804, the receiving routine 302 is configured to select the plurality of digital tasks 412 having a closest proximity with the assessor vector. Having selected a plurality of digital tasks 412 based on the vector proximity, the receiving routine 302 is configured to transmit a data packet 310 to the parameter routine 304, the data packet 310 comprising the plurality of digital tasks 412.

Step 806: Determining, for a Given Digital Task of the Plurality of Digital Tasks, a Respective Assessor Interaction Parameter, the Respective Assessor Interaction Parameter being Indicative of a Likelihood Value of the Given Assessor Selecting the Given Digital Task, the Assessor Interaction Parameter being Determined Based on at Least One or More Profile Parameters Associated with the Given Assessor

At step 806, in response to receiving the data packet 310, the parameter routine 304 is configured to determine a respective assessor interaction parameter for each digital task included within the plurality of digital tasks 412.

In some non-limiting embodiments of the present technology, the assessor interaction parameter is indicative of the likelihood value of the human assessor 106 (such as the human assessor 106) selecting a given digital task. More specifically, the parameter routine 304 is configured to determine a respective assessor interaction parameter for each digital tasks included within the plurality of digital tasks 412 (the first digital task 402, the second digital task 404, the third digital task 406, the fourth digital task 408 and the fifth digital task 410).

How the assessor interaction parameter is determined is not limited. In some non-limiting embodiments of the present technology, the parameter routine 304 is configured to execute a machine learning algorithm (not shown) trained to, for a given digital task, receive the assessor vector and the task feature vector associated with the given digital task and output the assessor interaction parameter associated with the given digital task. How the machine learning algorithm is trained is not limited and may for example, be based on a set of training assessor vectors, a set of training task feature vectors, and a set of training labels indicative of a presence of interaction between training assessors (illustrated by their respective training assessor vector) and each of the training digital tasks (illustrated by their respective training task feature vector).

Step 808: Obtaining, by the Processor, for the Given Digital Task, a Respective Accurate-Completion Parameter Accurate-Completion Parameter being Indicative of a Likelihood Value of the Given Assessor Completing the Given Digital Task Correctly

At step 808, the receiving routine is configured to determine the accurate-completion parameter for each digital task included within the plurality of digital tasks 412.

In some non-limiting embodiments of the present technology, the accurate-completion parameter is indicative of a likelihood value of the human assessor 106 (such as the human assessor 106) completing each digital task included within the plurality of digital tasks 412 (the first digital task 402, the second digital task 404, the third digital task 406, the fourth digital task 408 and the fifth digital task 410).

Step 810: Ranking, by the MLA, the Plurality of Digital Tasks to Generate a Ranked Plurality of Digital Tasks, the Ranking being Executed by Optimizing a Ranking Quality Parameter, the Ranking Quality Parameter being Determined Based on a Combination of: (i) a User-Platform Satisfaction Parameter Indicative of the Given Assessor being Satisfied Based on a Position of the Given Digital Task within a Ranked List of the Plurality of Digital Tasks, a Higher User-Platform Satisfaction Parameter being Indicative of the Position of the Given Digital Task within the List being Aligned with the at Least One or More Profile Parameters of the Given Assessor, the User-Platform Satisfaction Parameter being Determined Based on the Respective Assessor Interaction Parameter of the Plurality of Digital Tasks; (ii) a Requester-Platform Satisfaction Parameter Indicative of a Likelihood of the Given Assessor Correctly Completing the Given Digital Task, a Higher Requester-Platform Satisfaction Parameter being Indicative of the Given Assessor Correctly Completing the Given Digital Task being Positioned Higher within the Ranked List, the Requester-Platform Satisfaction Parameter being Determined Based on the Respective Accurate-Completion Parameter of the Plurality of Digital Tasks; the Optimizing Including Maximizing the Value of the Requester-Platform Satisfaction Parameter while Maintaining the Value of the User-Platform Satisfaction Parameter at a Given Predetermined Level

At step 810, in response to receiving the data packet 312, the ranking routine 306 is configured to generate a ranking quality parameter 604. In some non-limiting embodiments of the present technology, the ranking quality parameter 604 is one of an input feature for the MLA 314 to generate a ranked list 606 of the plurality of digital tasks 412.

In some non-limiting embodiments of the present technology, the ranking quality parameter 604 comprises the user-platform satisfaction parameter 504 and the requester-platform satisfaction parameter 602.

In some non-limiting embodiments of the present technology, the user-platform satisfaction parameter 504 is a proxy parameter of the human assessor 106 being satisfied with the positions of the digital tasks within the ranked list 606, and the requester-platform satisfaction parameter 602 is a proxy parameter of the requester(s) of the digital task(s) being satisfied with the position(s) of the digital task(s) within the ranked list 606 in order to achieve the number of human assessors who need to complete the same digital task.

In some non-limiting embodiments of the present technology, the MLA 314 is configured to generate the ranked list 606 by optimizing the ranking quality parameter 604. In some non-limiting embodiments of the present technology, the optimizing the ranking quality parameter 604 comprises maximizing the value of the requester-platform satisfaction parameter 602 while maintaining the value of the user-platform satisfaction parameter 504 to a predetermined target value. In other words, the MLA 314 is configured to generate the ranked list 606 that maximizes the requester-platform satisfaction parameter 602 while minimizing the dissatisfaction of the human assessor 106 (illustrated as a decreasing change in the user-platform satisfaction parameter 504) to the predetermined target value

Step 810: selecting, by the processor, from the ranked plurality of digital tasks, a top N-number of digital tasks for inclusion thereof in the list of digital tasks

At step 810, in response to the ranking routine 306 generating the ranked list 606, the ranking routine 306 is configured to transmit a data packet 316 to the electronic device 120 associated with the human assessor 106. The data packet 316 includes the ranked list 606.

It should be noted that the above examples are just one way of executing the optimizing of the ranking quality parameter. In at least some alternative non-limiting embodiments of the present technology, the method of optimizing the ranking quality parameter can be based on optimization of the so-called (i) an assessor interaction parameter and (ii) a displaced task parameter.

Within these embodiments of the present technology, the assessor interaction parameter is indicative of a predicted likelihood of interaction between the given assessor and a given digital task, based on a set of skills of the given assessor, a value of the assessor interaction parameter being greater for the given digital task having a greater value of the respective assessor interaction parameter is positioned at a higher position within the list of digital tasks. In at least some embodiments of the present technology, the assessor interaction parameter correlates to the completion, by the given assessor the task, and on a broader level ability of the platform to complete the digital tasks with the requisite number of assessors.

The displaced task parameter is indicative of a negative effect of displacing another digital task from the higher position to a lower position on a user-satisfaction of the given assessor with the crowd-sourced digital platform. As such, the displaced task parameter correlates to the user satisfaction degradation in response to certain digital tasks being positioned higher for certain assessors, and thus, displacing other digital tasks from higher ranked positions.

As such in accordance with alternative embodiments of the present technology, a method 900 can be executed.

Step 902: Receiving, by the Processor, a Request for the List of Digital Tasks from the Given Assessor

The method 900 starts at step 902, where the receiving routine 302 is configured to receive a data packet 308 from the human assessor 106. The data packet 308 comprises a request by a human assessor 106 for a list of digital tasks.

### Step 904: Retrieving a Plurality of Digital Tasks Available for Execution in the Crowd-Sourced Digital Platform

At step 904, the receiving routine 302 is configured to, in response to receive the data packet 308, access the task database 121 and retrieve a plurality of digital tasks. For example, the receiving routine 302 is configured to retrieve the plurality of digital tasks corresponding to digital tasks that have been recently submitted by one or more requesters and uncompleted by a predetermined number of human assessors.

Step 906: Generating, by the MLA, a Subset of Digital Tasks, the Generating being Executed by: Generating, by the MLA, a Feature Vector of the Given Accessor; Generating, by the MLA, a Respective Feature Vector for Each One of the Plurality of Digital Tasks; Selecting an N-Number of the Plurality of Digital Tasks as the Subset of Digital Tasks, Based on Vector-Proximity of the Feature Vector of the Given Accessor and Respective Feature Vectors of the Plurality of Digital Tasks

At step 906, the receiving routine 302 is configured to and retrieve the assessor data 112 associated with the human assessor 106 from the database 104.

In some non-limiting embodiments of the present technology, the receiving routine 302 is then configured to generate the vector representation of the assessor data 112. In some non-limiting embodiments of the present technology, the receiving routine 302 is further configured to access the task database 121 and select one or more digital tasks based on the assessor vector. More specifically, the receiving routine 302 is configured to generate the respective task feature vector for each digital task included within the task database 121 based on their respective task-specific data. The receiving routine 302 is then configured to calculate a respective vector-proximity of between the assessor vector and the one or more task feature vectors.

In some non-limiting embodiments of the present technology, the receiving routine 302 is further configured to select an N-number of digital tasks having a closest proximity with the assessor vector. It should be understood that the N-number may correspond to any number set by an administrator of the crowdsourcing application 118. Needless to say, instead of selecting N-number of digital tasks, it is also contemplated that the receiving routine 302 select one or more digital tasks having a vector-proximity value above a predefined threshold.

Having selected the plurality of digital tasks 412 based on the vector proximity, the receiving routine 302 is configured to transmit a data packet 310 to the parameter routine 304, the data packet 310 comprising the plurality of digital tasks 412.

Step 908: Ranking, by the MLA, the Subset of Digital Tasks into the List of Digital Tasks, the Ranking being Executed by Optimizing a Ranking Quality Parameter, the Ranking Quality Parameter being Determined Based on a Combination of: (i) an Assessor Interaction Parameter Indicative of a Predicted Likelihood of Interaction Between the Given Assessor and a Given Digital Task, Based on a Set of Skills of the Given Assessor, a Value of the Assessor Interaction Parameter being Greater for the Given Digital Task Having a Greater Value of the Respective Assessor Interaction Parameter is Positioned at a Higher Position within the List of Digital Tasks; (ii) a Displaced Task Parameter Indicative of a Negative Effect of Displacing Another Digital Task from the Higher Position to a Lower Position on a User-Satisfaction of the Given Assessor with the Crowd-Sourced Digital Platform

At step 908, in response to receiving the data packet 310, the parameter routine 304 is configured to determine a respective assessor interaction parameter for each digital task included within the plurality of digital tasks 412.

In some non-limiting embodiments of the present technology, the assessor interaction parameter is indicative of the likelihood value of the human assessor 106 (such as the human assessor 106) selecting a given digital task. More specifically, the parameter routine 304 is configured to determine a respective assessor interaction parameter for each digital tasks included within the plurality of digital tasks 412 (the first digital task 402, the second digital task 404, the third digital task 406, the fourth digital task 408 and the fifth digital task 410).

The parameter routine 304 is further configured to determine a displaced task parameter for each digital task included within the plurality of digital tasks 412.

In some non-limiting embodiments of the present technology, the displaced task parameter is indicative of a negative effect of displacing another digital task from the higher position to a lower position on a user-satisfaction of the given assessor with the crowd-sourced digital platform. As such, the displaced task parameter correlates to the user satisfaction degradation in response to certain digital tasks being positioned higher for certain assessors, and thus, displacing other digital tasks from higher ranked positions.

The ranking routine 306 is then configured to generate a ranking quality parameter 604. In some non-limiting embodiments of the present technology, the ranking quality parameter 604 is one of an input feature for the MLA 314 to generate a ranked list 606 of the plurality of digital tasks 412.

In some non-limiting embodiments of the present technology, the ranking quality parameter 604 comprises the assessor interaction parameter and the displaced task parameter.

Step 910: The Optimizing Including Maximizing the Value of the Assessor Interaction Parameter while Maintaining the Value of the Displaced Task Parameter at a Given Predetermined Level

At step 910, the MLA 314 is configured to generate the ranked list 606 by optimizing the ranking quality parameter 604. In some non-limiting embodiments of the present technology, the optimizing the ranking quality parameter 604 comprises maximizing the value of the assessor interaction parameter while maintaining the value of the displaced task parameter to a predetermined target value. In other words, the MLA 314 is configured to generate the ranked list 606 that maximizes the assessor interaction parameter while minimizing the dissatisfaction of the human assessor 106 (illustrated as a decreasing change in the displaced task parameter) to the predetermined target value.

It should be apparent to those skilled in the art that at least some embodiments of the present technology aim to expand a range of technical solutions for addressing a particular technical problem encountered by the conventional crowdsourcing technology, namely allocating a task of an unknown type to a given human assessor.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or reordered without departing from the teachings of the present technology. Accordingly, the order and grouping of the steps is not a limitation of the present technology.

1. A computer-implemented method of generating a list of digital tasks to be provided to a given assessor for selecting for completion of at least one thereof, the given assessor being part of a crowd-sourced digital platform, the method being executable by a server hosting the crowd-sourced digital platform, the server comprising at least one processor, the method comprising:
receiving, by the at least one processor, a request for the list of digital tasks from the given assessor;
retrieving a plurality of digital tasks available for execution in the crowd-sourced digital platform responsive to the request;
determining, for a given digital task of the plurality of digital tasks, and by a first machine learning algorithm (MLA) trained to receive an assessor vector and a task vector corresponding to a digital task and output an assessor interaction parameter corresponding to the digital task, a respective assessor interaction parameter, the respective assessor interaction parameter being indicative of a likelihood value of the given assessor selecting the given digital task, the assessor interaction parameter being determined based on at least one or more profile parameters associated with the given assessor;
determining, for the given digital task, and by a second MLA trained to receive an assessor vector and a task vector and output an accurate-completion parameter, a respective accurate-completion parameter, the accurate-completion parameter being indicative of a likelihood value of the given assessor completing the given digital task correctly;
ranking, by a third MLA trained to generate a ranked list of digital tasks, the plurality of digital tasks to generate a ranked plurality of digital tasks, the ranking being executed by optimizing a ranking quality parameter, the ranking quality parameter being determined based on a combination of:
(i) a user-platform satisfaction parameter indicative of the given assessor being satisfied based on a position of the given digital task within a ranked list of the plurality of digital tasks, a higher user-platform satisfaction parameter being indicative of the position of the given digital task within the list being aligned with the at least one or more profile parameters of the given assessor, the user-platform satisfaction parameter being determined based on the respective assessor interaction parameter of the plurality of digital tasks;
(ii) a requester-platform satisfaction parameter indicative of a likelihood of the given assessor correctly completing the given digital task, a higher requester-platform satisfaction parameter being indicative of the given assessor correctly completing the given digital task being positioned higher within the ranked list, the requester-platform satisfaction parameter being determined based on the respective accurate-completion parameter of the plurality of digital tasks;
the optimizing including maximizing the value of the requester-platform satisfaction parameter while maintaining the value of the user-platform satisfaction parameter at a given predetermined level; and
selecting, by the at least one processor, from the ranked plurality of digital tasks, a top N-number of digital tasks for inclusion thereof in the list of digital tasks.

2. The method of claim 1, wherein the retrieving the plurality of digital tasks available for execution further comprises determining therein a subset of digital tasks, the determining including:
generating, by a fourth MLA, a feature vector of the given accessor;
generating, by the fourth MLA, a respective feature vector for each digital task of the plurality of digital tasks; and
selecting, by the at least one processor, an N-number of digital tasks from the plurality of digital tasks for inclusion thereof in the subset of digital tasks, based on vector-proximity of the feature vector of the given accessor and respective feature vectors of the plurality of digital tasks.

3. The method of claim 1, wherein the user-platform satisfaction parameter is an aggregate value of the assessor interaction parameters associated with the plurality of digital tasks.

4. The method of claim 1, wherein the requester-platform satisfaction parameter is an aggregate value of the accurate-completion parameters associated with the plurality of digital tasks.

5. The method of claim 1, wherein the respective assessor interaction parameter is indicative of whether the given assessor would click the given digital task or not.

6. The method of claim 1, wherein the respective accurate-completion parameter is determined using control digital tasks.

7. The method of claim 1, wherein the respective accurate-completion parameter is determined based on a degree of consistency of an answer provided to the given digital task by the given assessor with other answers provided to the given digital task by other assessors of the crowd-sourced platform.

8. The method of claim 1, wherein the given digital task is of a respective predetermined type, and the respective accurate-completion parameter is indicative of a set of skills of the given assessor in completing digital tasks of the respective predetermined type.

9. The method of claim 1, wherein the ranking quality parameter is determined in accordance with an equation:
$$α {\sum }_{r ∈ R} {{\sum }_{i = 1}}^{20} \frac{rel ( {w}_{r} , c ( F ( r ) , i ) )}{log ( i + 1 )} + β {\sum }_{r ∈ R} {{\sum }_{i = 1}}^{20} \frac{acc ( r , {w}_{r} , c ( F ( r ) , i ) )}{log ( i + 1 )} \to {max}_{c ∈ C} ,$$
where rel(wᵣ, c(F(r), i)) is the respective assessor interaction parameter of the given assessor wᵣ with the given digital task F(r);
acc(r, wᵣ, c(F(r), i)) is the respective accurate-completion parameter associated with the given assessor wᵣ completing the given digital task F(r);
i is a current position of the given digital task within the list of digital tasks;
r is the request used for generating the given digital task;
c is one of learning functions of the MLA; and
α and β are weight coefficients.

10. The method of claim 9, wherein the optimizing includes applying one of a Stochastic Rank algorithm and a Yeti Rank Algorithm.

11. The method of claim 9, wherein the third MLA comprises an ensemble of CatBoost decision trees.

12. A system for generating a list of digital tasks to be provided to a given assessor for selecting for completion of at least one thereof, the given assessor being part of a crowd-sourced digital platform, the system comprising at least one server, the at least one server hosting the crowd-sourced digital platform, the at least one server comprising at least one processor and memory storing executable instructions which, when executed by the at least one processor, cause the system to:
receive a request for the list of digital tasks from the given assessor;
retrieve a plurality of digital tasks available for execution in the crowd-sourced digital platform responsive to the request;
determine, for a given digital task of the plurality of digital tasks, a respective assessor interaction parameter, the respective assessor interaction parameter being indicative of a likelihood value of the given assessor selecting the given digital task, the assessor interaction parameter being determined based on at least one or more profile parameters associated with the given assessor;
obtain, for the given digital task, a respective accurate-completion parameter, the accurate-completion parameter being indicative of a likelihood value of the given assessor completing the given digital task correctly;
rank, by a Machine Learning algorithm (MLA), the plurality of digital tasks to generate a ranked plurality of digital tasks, the ranking being executed by optimizing a ranking quality parameter, the ranking quality parameter being determined based on a combination of:
(i) a user-platform satisfaction parameter indicative of the given assessor being satisfied based on a position of the given digital task within a ranked list of the plurality of digital tasks, a higher user-platform satisfaction parameter being indicative of the position of the given digital task within the list being aligned with the at least one or more profile parameters of the given assessor, the user-platform satisfaction parameter being determined based on the respective assessor interaction parameter of the plurality of digital tasks;
(ii) a requester-platform satisfaction parameter indicative of a likelihood of the given assessor correctly completing the given digital task, a higher requester-platform satisfaction parameter being indicative of the given assessor correctly completing the given digital task being positioned higher within the ranked list, the requester-platform satisfaction parameter being determined based on the respective accurate-completion parameter of the plurality of digital tasks;
the optimizing including maximizing the value of the requester-platform satisfaction parameter while maintaining the value of the user-platform satisfaction parameter at a given predetermined level; and
select, from the ranked plurality of digital tasks, a top N-number of digital tasks for inclusion thereof in the list of digital tasks.

13. The system of claim 12, wherein the instructions that cause the system to retrieve the plurality of digital tasks available for execution, comprise instructions that cause the system to determine therein a subset of digital tasks, the determining comprising:
generating, by the MLA, a feature vector of the given accessor;
generating, by the MLA, a respective feature vector for each digital tasks of the plurality of digital tasks; and
selecting an N-number of digital tasks from the plurality of digital tasks for inclusion thereof in the subset of digital tasks, based on vector-proximity of the feature vector of the given accessor and respective feature vectors of the plurality of digital tasks.

14. The system of claim 12, wherein the user-platform satisfaction parameter is an aggregate value of the assessor interaction parameters associated with the plurality of digital tasks.

15. The system of claim 12, wherein the requester-platform satisfaction parameter is an aggregate value of the accurate-completion parameters associated with the plurality of digital tasks.

16. The system of claim 12, wherein the respective assessor interaction parameter is indicative of whether the given assessor would click the given digital task or not.

17. The system of claim 12, wherein the respective accurate-completion parameter is determined based on a degree of consistency of an answer provided to the given digital task by the given assessor with other answers provided to the given digital task by other assessors of the crowd-sourced platform.

18. A computer-implemented method of generating a list of digital tasks to be provided to a given assessor for selecting for completion of at least one thereof, the given assessor being part of a crowd-sourced digital platform, the method being executable by a server hosting the crowd-sourced digital platform, the server comprising at least one processor configured to execute a Machine-Learning algorithm (MLA), the method comprising:
receiving, by the at least one processor, a request for the list of digital tasks from the given assessor;
retrieving a plurality of digital tasks available for execution in the crowd-sourced digital platform responsive to the request;
determining, for a given digital task of the plurality of digital tasks, a respective assessor interaction parameter, the respective assessor interaction parameter being indicative of a likelihood value of the given assessor selecting the given digital task, the assessor interaction parameter being determined based on at least one or more profile parameters associated with the given assessor;
obtaining, by the at least one processor, for the given digital task, a respective accurate-completion parameter accurate-completion parameter being indicative of a likelihood value of the given assessor completing the given digital task correctly;
ranking, by the MLA, the plurality of digital tasks to generate a ranked plurality of digital tasks, the ranking being executed by optimizing a ranking quality parameter, the ranking quality parameter being determined based on a combination of:
(i) a user-platform satisfaction parameter indicative of the given assessor being satisfied based on a position of the given digital task within a ranked list of the plurality of digital tasks, a higher user-platform satisfaction parameter being indicative of the position of the given digital task within the list being aligned with the at least one or more profile parameters of the given assessor, the user-platform satisfaction parameter being determined based on the respective assessor interaction parameter of the plurality of digital tasks;
(ii) a requester-platform satisfaction parameter indicative of a likelihood of the given assessor correctly completing the given digital task, a higher requester-platform satisfaction parameter being indicative of the given assessor correctly completing the given digital task being positioned higher within the ranked list, the requester-platform satisfaction parameter being determined based on the respective accurate-completion parameter of the plurality of digital tasks;
the optimizing including maximizing the value of the requester-platform satisfaction parameter while maintaining the value of the user-platform satisfaction parameter at a given predetermined level; and
selecting, by the at least one processor, from the ranked plurality of digital tasks, a top N-number of digital tasks for inclusion thereof in the list of digital tasks.

19. The method of claim 18, wherein the retrieving the plurality of digital tasks available for execution further comprises determining therein a subset of digital tasks, the determining including:
generating, by the MLA, a feature vector of the given accessor;
generating, by the MLA, a respective feature vector for each digital tasks of the plurality of digital tasks; and
selecting, by the at least one processor, an N-number of digital tasks from the plurality of digital tasks for inclusion thereof in the subset of digital tasks, based on vector-proximity of the feature vector of the given accessor and respective feature vectors of the plurality of digital tasks.

20. The method of claim 18, wherein the user-platform satisfaction parameter is an aggregate value of the assessor interaction parameters associated with the plurality of digital tasks.
